(19) United States
(12) Patent Application Publication
(10) Pub. No.: US 2012/0124918 A1
(43) Pub. Date: May 24, 2012

(54) PARAPET PROTECTOR

(76) Inventor: William Bing Zimmerman, Mill Creek, WA (US)

(21) Appl. No.: 13/110,811

(22) Filed: May 18, 2011

Related U.S. Application Data
(60) Provisional application No. 61/345,889, filed on May 18, 2010.

(51) Int. Cl. A01M 29/26; E04B 1/62; E04B 1/72

(52) U.S. Cl. 52/101; 52/173.1

(57) ABSTRACT

A parapet protector is disclosed which generally discourages birds, small mammals, and other nuisance animals from the rooftops of buildings. The parapet protector includes a first insulator detachably attached to a surface of a building; a first suspension eye coupled to the first insulator, the first suspension eye extending outwardly from the first insulator in a direction that is perpendicular to a plane defined by the surface of the building; a first spring that is detachably attached to a distal end of the first suspension eye; a wire that that connects the first spring to a second spring located on a second suspension eye coupled to a second insulator; and an electrical input that is configured to electrify the wire.

### PRIORITY CLAIM

The present application claims priority from and the benefit of U.S. Provisional Application No. 61/345,889 filed May 18, 2010, which is herein incorporated by reference.

### BACKGROUND OF THE DISCLOSURE

### Field of the Invention

The embodiments disclosed herein generally refer to the field of rooftop animal deterrence consisting of a raised plurality of wires which are electrified to substantially deter animals from resting upon or residing upon the upper ledges and surfaces of a structure.

### BRIEF DESCRIPTION OF THE DRAWINGS

FIG. 1 is an environmental view of one embodiment of the disclosure in several configurations;

FIG. 2 is an environmental view of one embodiment of the disclosure showing a corner configuration; and

FIGS. 3-21 are multiple views of one embodiment of the disclosure in several configurations.

### DETAILED DESCRIPTION

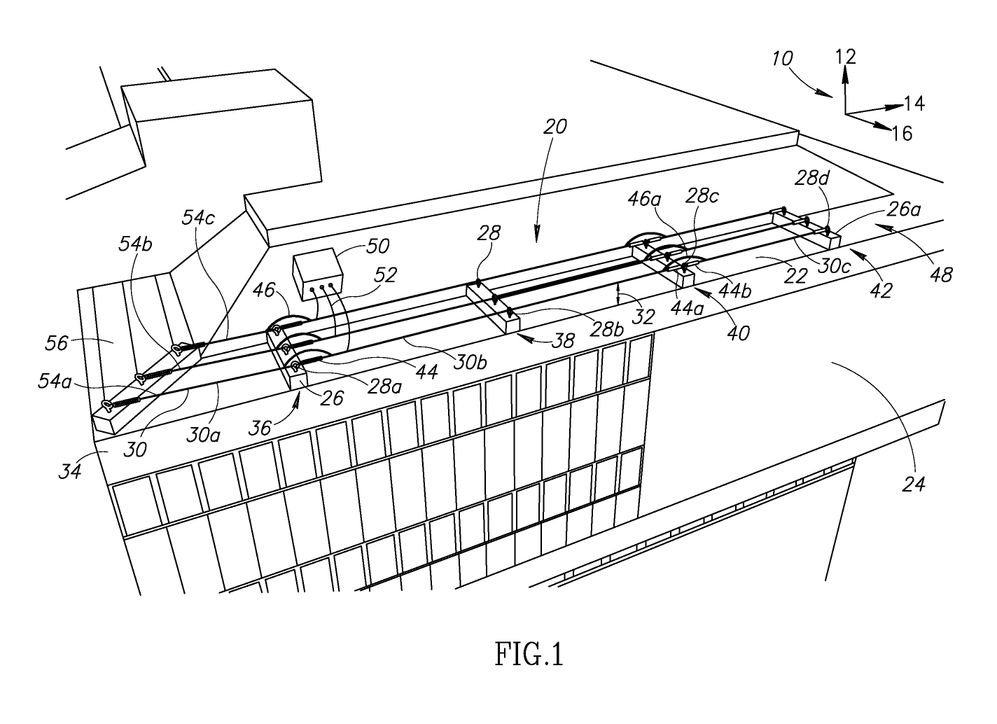

Before beginning, an axes system 10 is disclosed in FIG. 1 and is generally comprised of vertical axis 12, longitudinal axis 14, and transverse axis 16. These axes are for ease of understanding and description and are not intended to be limiting.

In one embodiment, as shown in FIG. 1, a parapet protector 20 is disclosed which generally discourages birds, small mammals, and other nuisance animals from the rooftops of buildings. It is well known that pigeons, seagulls, squirrels, and other animals and their droppings are detrimental to the appearance of buildings and can negatively affect community health concerns among humans. Bird droppings are especially well known to cause substantial and sometimes permanent damage to structures and vehicles. Thus, a safe and efficient way to keep said animals from the roofs of structures is desired.

Prior art solutions, such as raised wire products, are substantially high above the parapet or structure and allow smaller birds and small mammals to pass under the wires. Furthermore, these raised wire systems require modification to the structure in that the upright posts are screwed or similarly fastened to the structure. Another disadvantage of the prior art system is that window washers or building maintenance personnel cannot remove the wires prior to working over the side of the structure and therefore damage the system. The Applicant has devised a system to overcome these deficiencies and simultaneously increase the visual appeal of the overall structure as the parapet protectors 20 are not substantially visible from a position vertically below the horizontal plane of the parapet 22 of the structure 24.

Referring again to FIG. 1, a parapet protector 20 is shown installed upon the parapet 22 of a structure 24. The parapet protector 20 in one form comprises an insulator 26 which is generally adhered to the parapet 22. This insulator 26 may be linear, or non-linear to conform to the adjacent surface of the structure. Several different fastening systems can be utilized; however, an adhesive is beneficial in that it does not compromise the watertight integrity of the structure 24. Positioned upon or partially within the insulator 26 is a plurality of suspension eyes 28. The suspension eyes 28 can comprise standard screw eyes, bolt eyes, or equivalent structures. The insulator 26 and suspension eye 28 generally maintain the wire 30 a sufficient height 32 above the parapet 22 in the vertical direction. The height 32 in one form is between 1-inch to 4-inches, which allows the wires 30 to be electrified and not come into substantial contact with the parapet 22 and still not so high as to be a visual distraction from below or to allow most animals to travel between the wire 30 and the parapet 22.

Several unique methods of coupling the wires 30 to the suspension eyes 28 are shown, including a corner configuration 34, a single spring configuration 36, a spring-less configuration 38, a double spring configuration 40, as well as an end configuration 42. The corner configuration 34 is generally used on the corner of a structure 24 such that the parapet protector 20 can traverse the corner from a first longitudinal direction to another orientation. In one example such as from a transverse direction 16 to a longitudinal direction 14 and still retain a desired orientation such that the adjacent wires 30 are substantially in parallel to each other from one insulator to another. In the single-spring configuration 36, the wires 30a are attached directly to the suspension eye 28a and the adjacent wire 30b is coupled to the suspension eye 28a through a tension spring 44. To ensure adequate electrical conductivity at this connection, a jumper 46 may be utilized. The jumper 46 is electrically coupled at one end to the wire 30a and electrically coupled to the wire 30b, thus allowing electrical current to flow around the suspension eye 28a and the tension spring 44. In another configuration, the wires 30 pass through the suspension eye 28b in a spring-less configuration 38. Another configuration may be utilized consisting of a double spring configuration 40. In this double spring configuration 40 a tension spring 44a and a tension spring 44b are positioned on either side of a suspension eye 28c. As with the single spring configuration 36, a jumper 46a can be utilized such that electrical current need not pass through the substantially weak connection points between the wire and the springs and between the springs and the suspension eye. In an end configuration 42, the insulator 26a can be utilized wherein the wire 30c terminates at the suspension eye 28d with or without a spring 44. This configuration may be utilized wherein the area 48 adjacent the insulator 26a is not protected, such as due to a chimney, fire escape, or other structure.

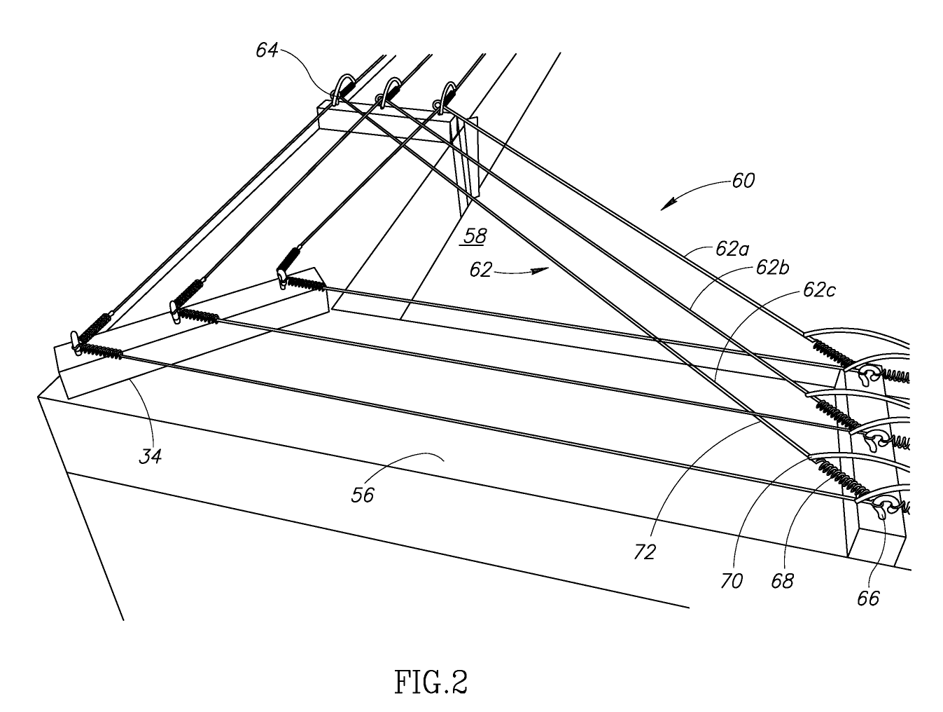

To provide electrical current to the wires 30, a power supply 50 is disclosed which is connected to the wires 30 by a plurality of supply wires 52. The power supply 50 can be of many different sorts as commonly used in electrified fencing. There are several different ways in which the power supply 50 can be oriented, such as by alternating current through the device, such that an animal contacting an adjacent pair of wires 54a and 54b or alternatively 54b and 54c would close the circuit between the two adjacent wires, thus receiving a mild electric shock which would tend to deter them from that structure. In another form, the parapets upper surface 56 may be a portion of the circuit such that an animal contacting a single wire 30 and simultaneously contacting the parapet would close the circuit, and thus receive a mild electric shock. One distinct advantage of this system over prior art systems is that in one form, a downward force placed upon the wires 30 would reposition them against the upper surface 56 of the parapet 22 without causing damage to the person or machinery exerting said force nor to the parapet 22 or the system. In this way, window cleaners and maintenance personnel can work over the side of the structure by laying tarps, ropes, or other hardware over the top of the wires and suspending themselves from the parapet in currently known ways. To this end, the entire parapet protector 20 can consist of separate unique power districts, say for example, the four sides of the structure such that maintenance personnel working over the north side of the structure can turn off electrical connection thereto but maintain electrical protection of the other three sides. When the window cleaners or maintenance personnel have completed their tasks, they need only remove their hardware which repositions the wires 30 to their raised position due to the springs, and re-energize the power supply 50. In some rooftops wherein the roof surface 58 is oriented substantially below the parapet upper surface 56 as shown in FIG. 2, the inside corners of such structures provide a haven for birds and other animals. Thus, an inside corner configuration 60 has been devised which substantially protects the corner space between adjacent upper surfaces forming an inside corner. In this configuration, an additional wire set 62 including wires 62a, 62b and 62c is attached at one end to a suspension eye 64 and at a second end to a suspension eye 66. At one or both ends a tension spring 68 can be utilized as previously discussed. In the orientation as shown, a jumper 70 can be utilized to provide improved electrical conductivity across the tension spring 68. Additionally, it may be desired to provide one or more of the wires with an insulating covering where the wire forms a junction 72 with a wire in a different orientation. These junctions 72 potentially pose a problem wherein the electrical current is not identical between the wires in question and the junctions of the two wires could form a short and close the circuit, potentially harming the parapet protector 20 and also potentially causing damage to the structure, or power supply 50. Alternatively, the inside corner configuration 60 may be positioned vertically above or below the wires comprising a standard corner configuration 34 to eliminate any potential short-circuit between the configurations.

As shown and described thus far, the parapet protector 20 is positioned upon a parapet upper surface 56 which is substantially horizontal. Due to the arrangement of the device, the device can be positioned at any orientation from horizontal to vertical and thus can be used not only on horizontal surfaces such as rooftops, parapets, railings, and balconies but could also be utilized on vertical surfaces, such as the outer wall, or across openings or windows. Alternatively, the parapet protector 20 can overlap other external hardware such as gutters without substantially hindering the operation thereof.

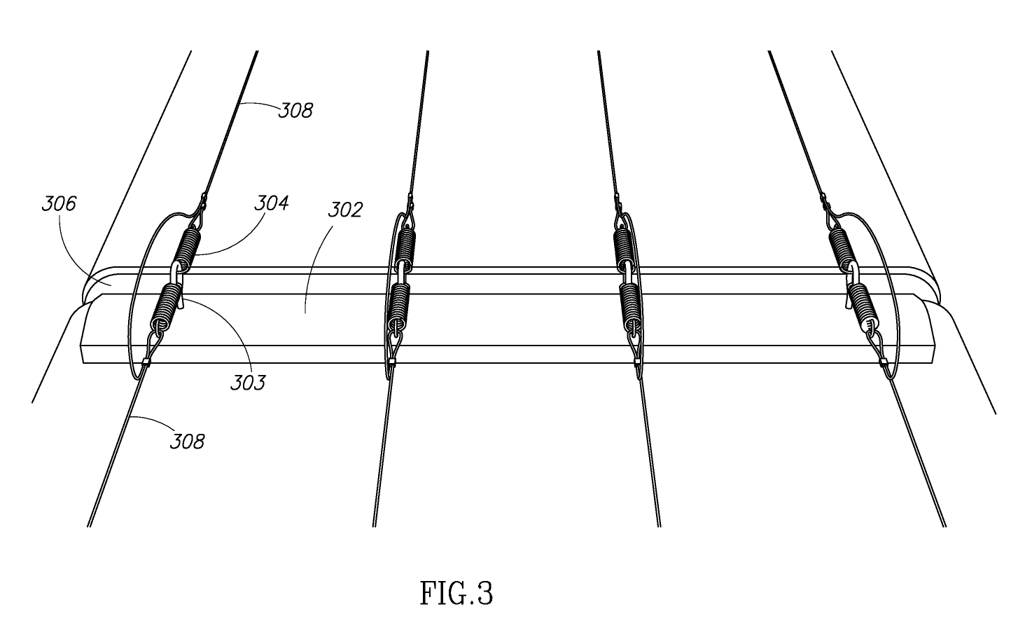

FIGS. 3-21 are multiple views of one embodiment of the disclosure in several configurations.

FIG. 3 shows an example embodiment of the parapet protector. In an example embodiment, the insulator 302 is placed in a depression between sections of the building. The post 303 is shown as extending out of the depression and rising to an example height of one inch to four inches, although any height may be used. The springs 304 are attached to a distal end of the post 303. Wires are attached to the springs 304 and extend outwardly toward another insulator (not shown). The wires 308 are connected via a jumper 306. In some embodiments, the combination of at least one spring and a wire may be referred to as a suspension system. In some embodiments a suspensions system is defined by a wire with a spring at each end of the wire, however in other embodiments there may only be a single spring.

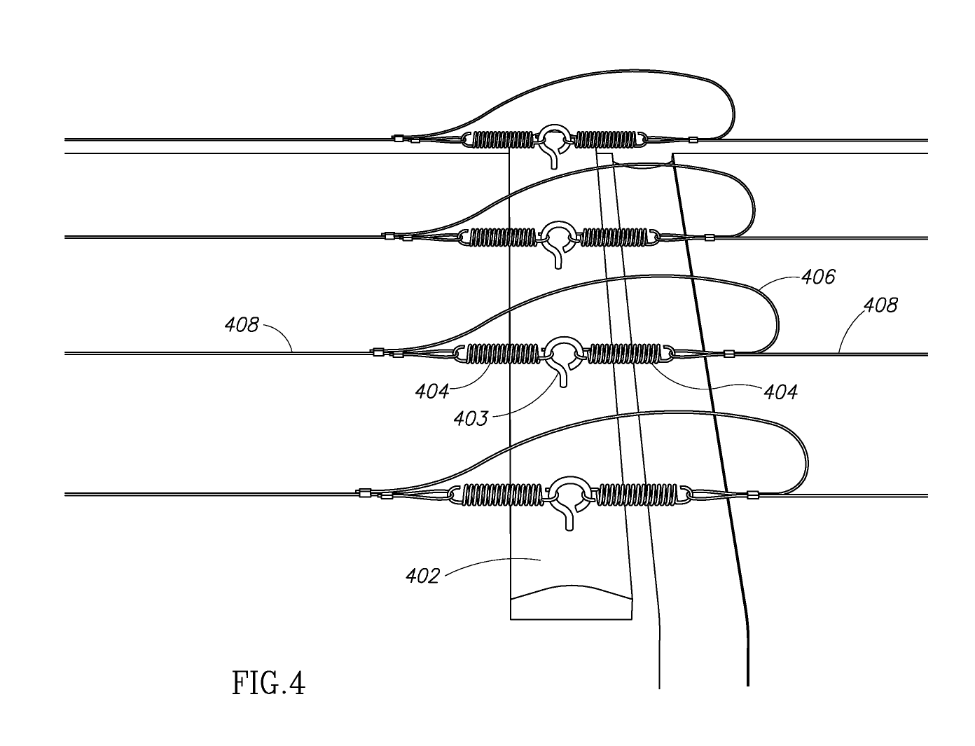

FIG. 4 shows an example embodiment of the parapet protector. In this example the insulator 402 is attached to the building surface with an adhesive. The insulator has a set of posts 403 attached to the insulator 402. The springs 404 are attached to a distal end of the post 403. Wires are attached to the springs 404 and extend outwardly toward another insulator (not shown). The wires 408 are connected via a jumper 406.

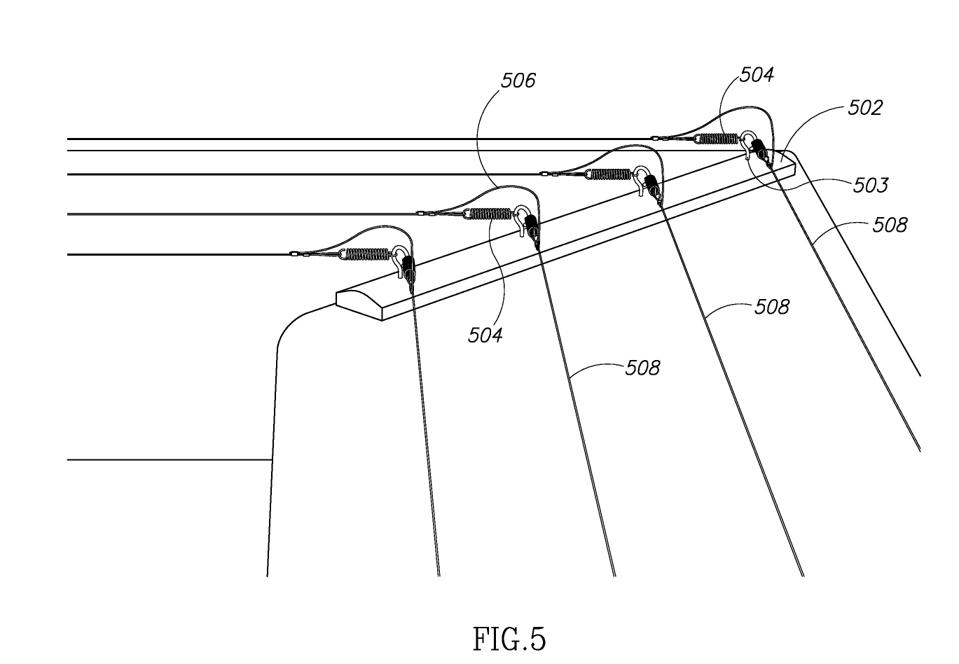

FIG. 5 shows an example embodiment of the parapet protector. In this example the insulator 502 is attached at a generally 45 degree angle to the building surface with an adhesive. Other attachment means include but are not limited to a bolted connection, magnetic connection and/or the like. The building generally comes to a right angle in this example. The insulator has a set of posts 503 attached to the insulator 502. The springs 504 are attached to a distal end of the post 503. Wires are attached to the springs 504 and extend outwardly toward another insulator (not shown). The wires 508 are connected via a jumper 506.

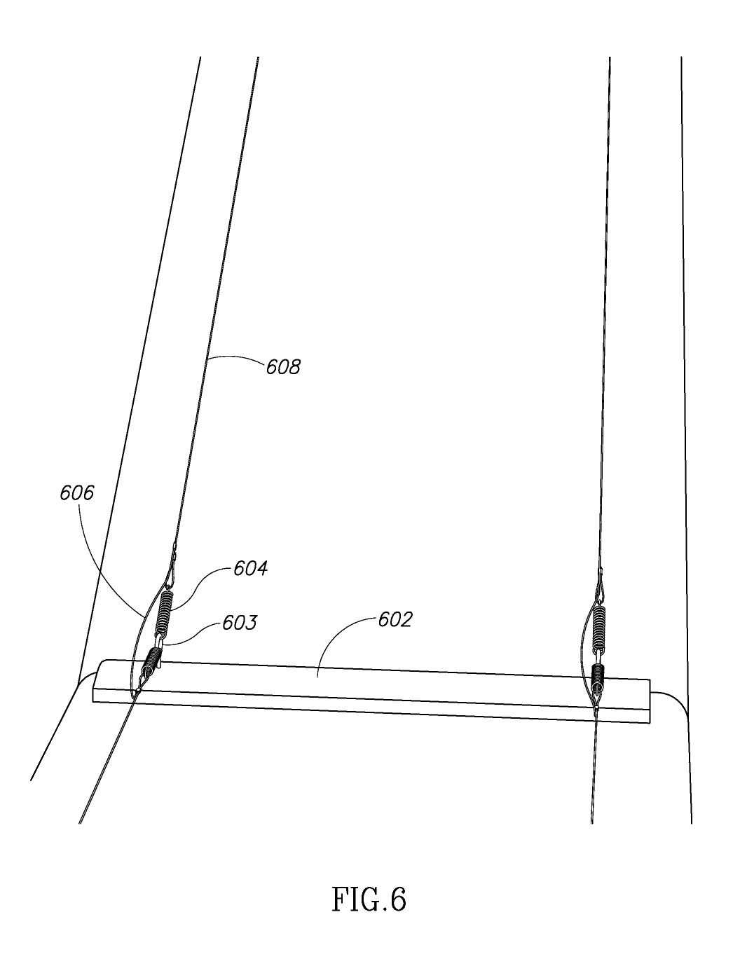

FIG. 6 shows an example embodiment of the parapet protector. In this example the insulator 602 is attached to the building surface. The insulator 602 is raised off of the building surface to account for the building rise. The insulator has a set of posts 603 attached to the insulator 602. The springs 604 are attached to a distal end of the post 603. Wires are attached to the springs 604 and extend outwardly toward another insulator (not shown). The wires 608 are connected via a jumper 606.

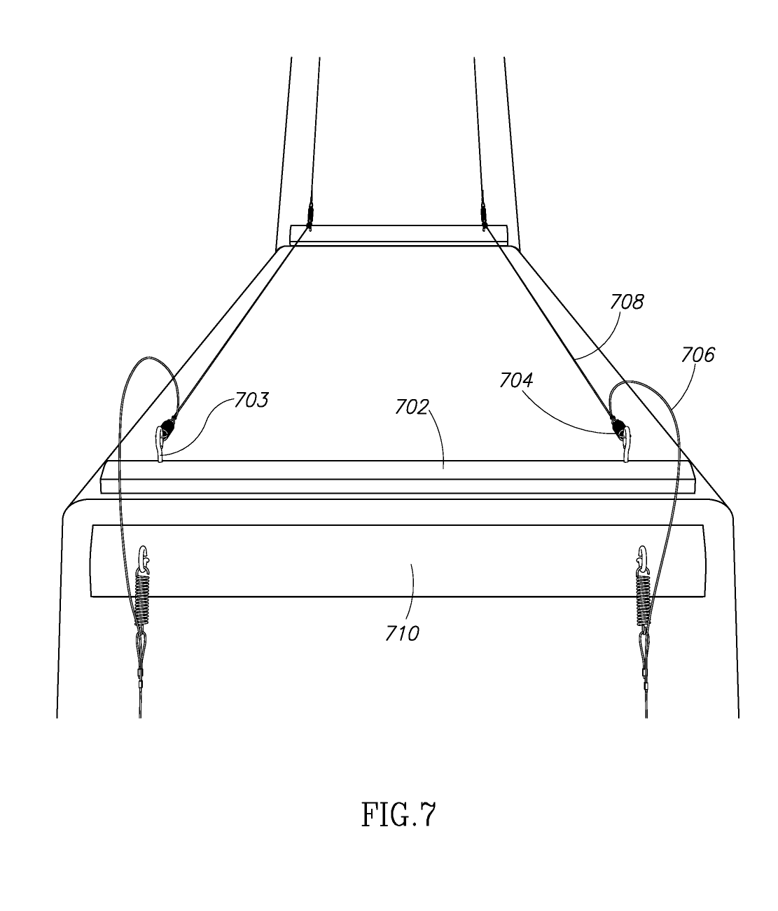

FIG. 7 shows an example embodiment of the parapet protector. In this example the insulator 702 is attached to the building surface with an adhesive. The insulator has a set of posts 703 attached to the insulator 702. The springs 704 are attached to a distal end of the post 703. Wires are attached to the springs 704 and extend outwardly toward another insulator 712. The wires 708 are connected via a jumper 706 to the wires 708 extending from insulator 710. Insulator 710 is generally placed on an opposite side of a corner of the building.

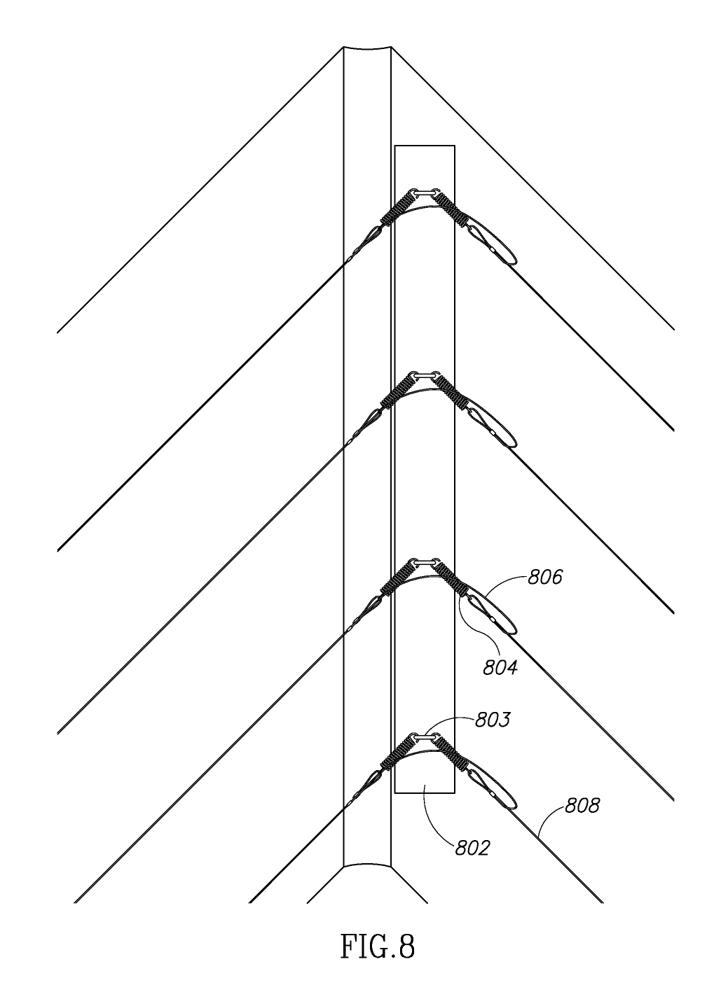

FIG. 8 shows an example embodiment of the parapet protector. In this example the insulator 802 is attached to the building surface with an adhesive. The insulator has a set of posts 803 attached to the insulator 802. The springs 804 are attached to a distal end of the post 803. Wires are attached to the springs 804 and extend outwardly toward another insulator (not shown). The wires 808 are connected via a jumper 806.

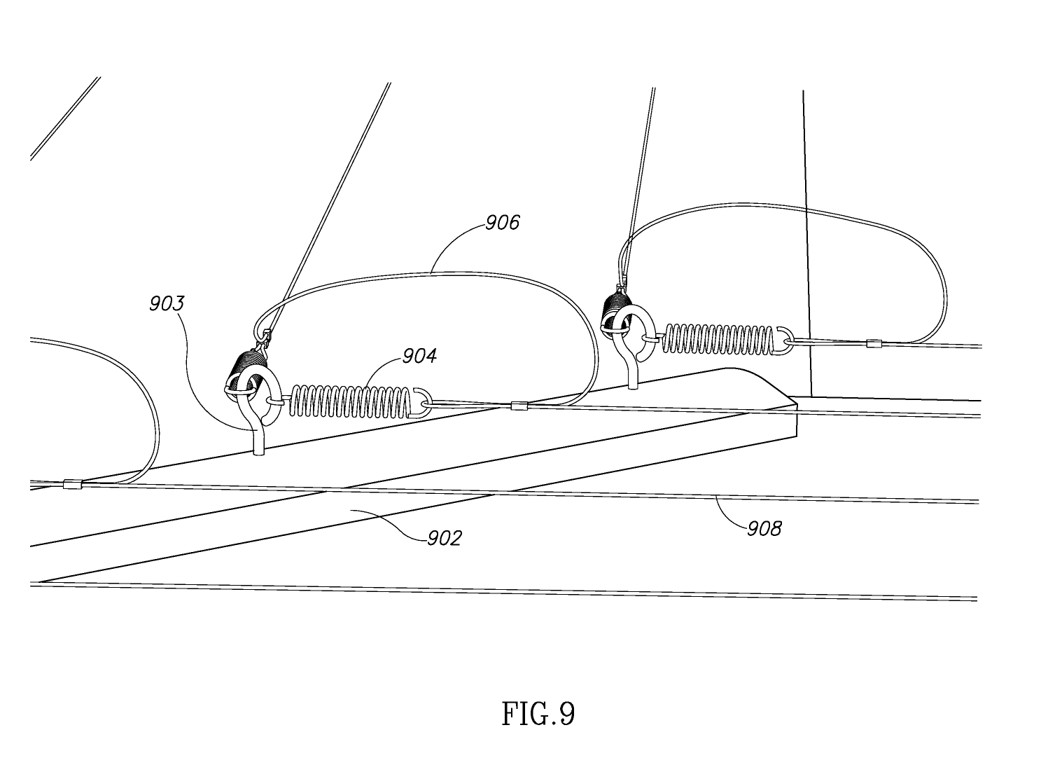

FIG. 9 shows an example embodiment of the parapet protector. In this example the insulator 902 is attached to the building surface with an adhesive. The insulator has a set of posts 903 attached to the insulator 902. The springs 904 are attached to a distal end of the post 903. Wires are attached to the springs 904 and extend outwardly toward another insulator (not shown). The wires 908 are connected via a jumper 906.

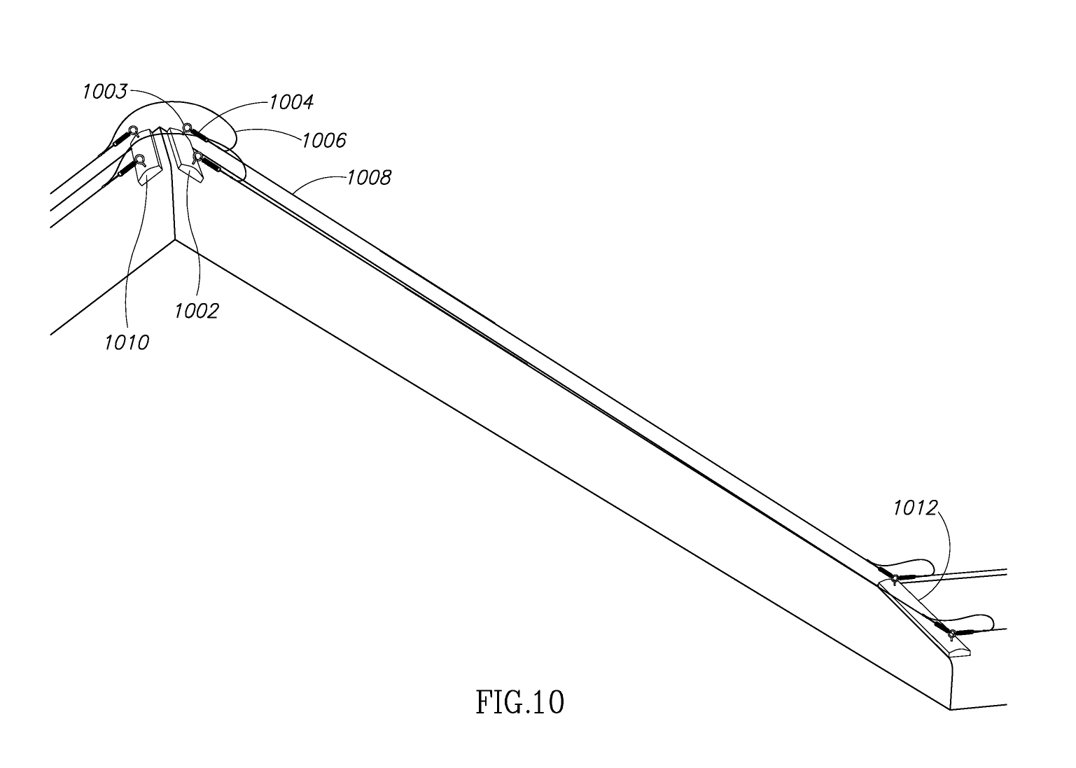

FIG. 10 shows an example embodiment of the parapet protector. In this example the insulator 1002 is attached to the building surface with an adhesive. The insulator has a set of posts 1003 attached to the insulator 1002. The springs 1004 are attached to a distal end of the post 1003. Wires are attached to the springs 1004 and extend outwardly toward another insulator 1012. The wires 1008 are connected via a jumper 1006 to the wires 1008 extending from insulator 1010. Insulator 1010 is generally placed on an opposite side of a corner of the building.

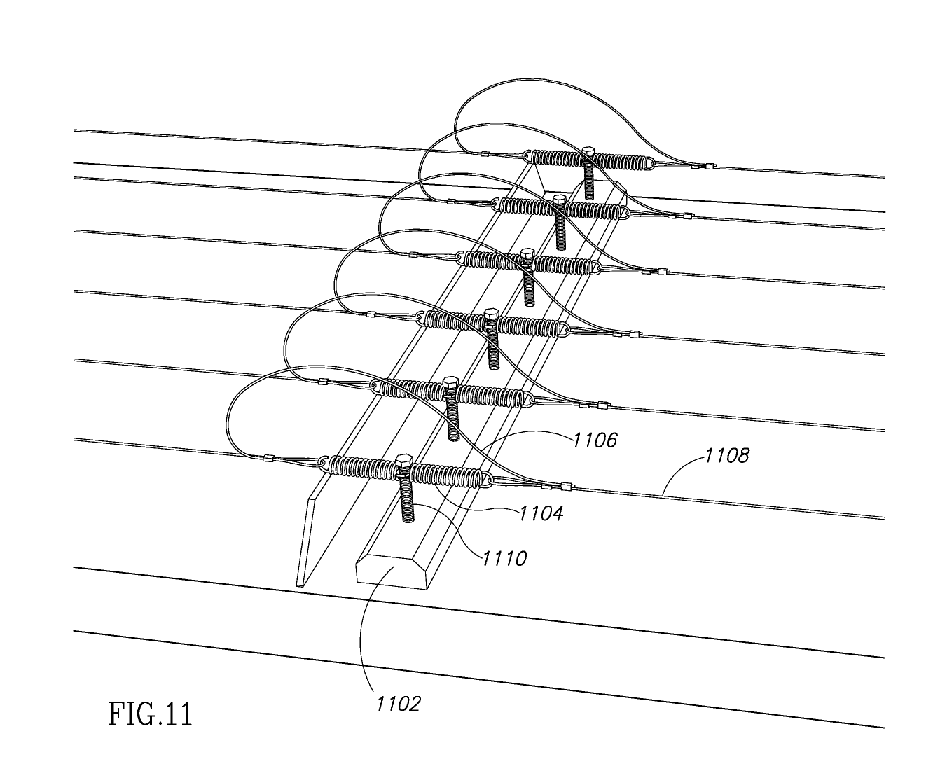

FIG. 11 shows an example embodiment of the parapet protector. In this example the insulator 1102 is attached to the building surface with an adhesive. The insulator has a set of posts 1110 attached to the insulator 1102. The posts 1110, in an embodiment, are screws that are height adjustable. The springs 1104 are attached to a distal end of the post 1110. Wires are attached to the springs 1104 and extend outwardly toward another insulator (not shown). The wires 1108 are connected via a jumper 1106.

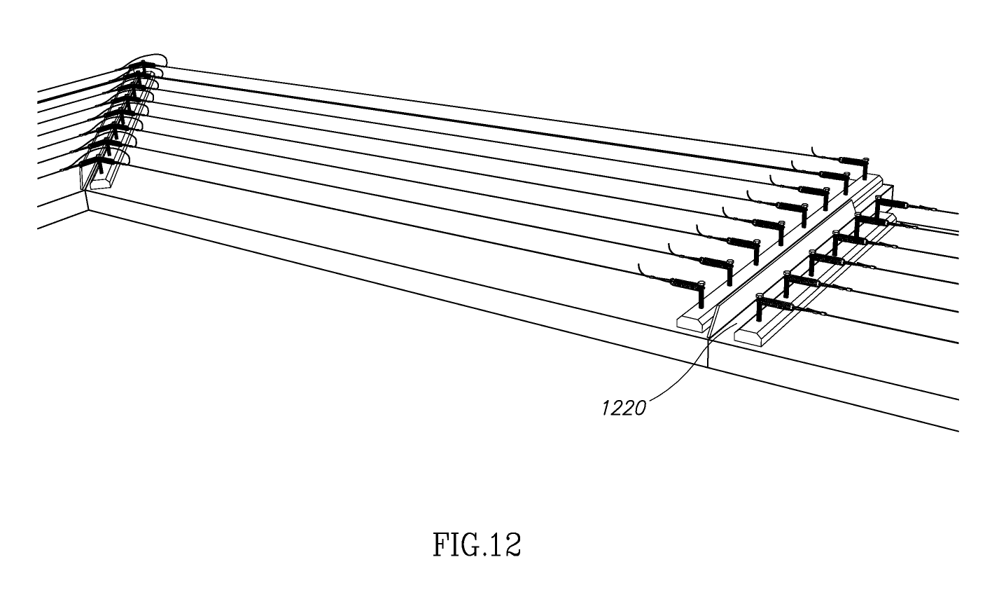

FIG. 12 shows an example parapet protector, wherein the parapet protectors are placed on opposite sides of two roof sections as defined by divider 1220. Such a solution reduces cost of replacement and maintenance if a single section has to be removed or replaced.

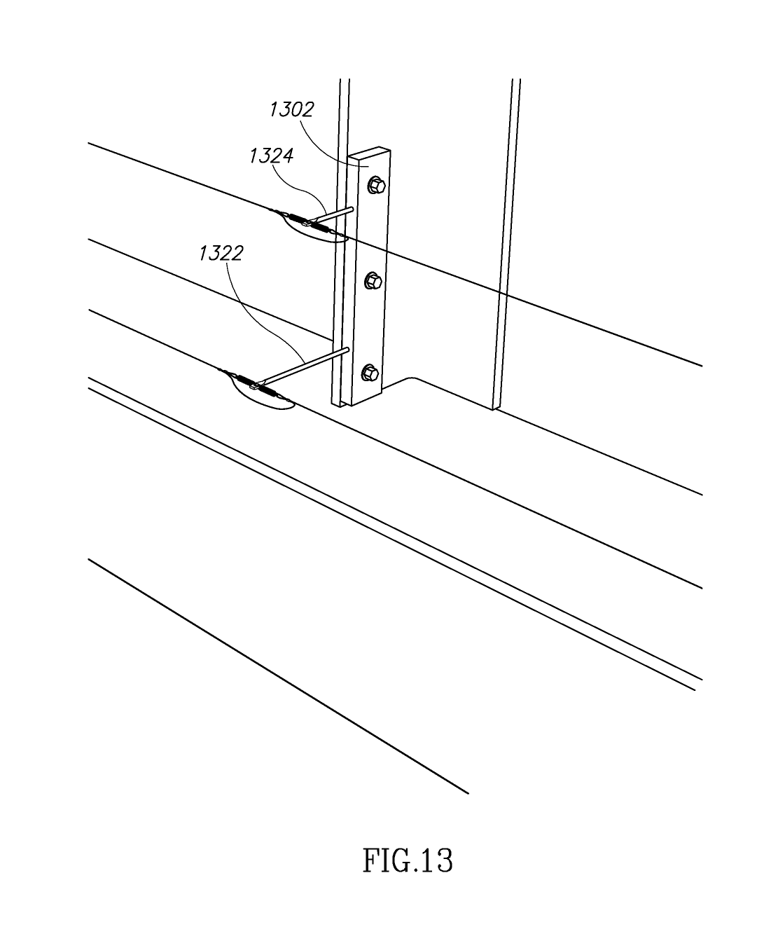

FIG. 13 shows an example parapet protector. An insulator 1302 is bolted to a building structure. The insulator has posts 1324 and 1322. Each of the posts 1324 and 1322 extend from the building at different lengths. Such an installation may be advantageous when the parapet protector is installed in a vertical direction.

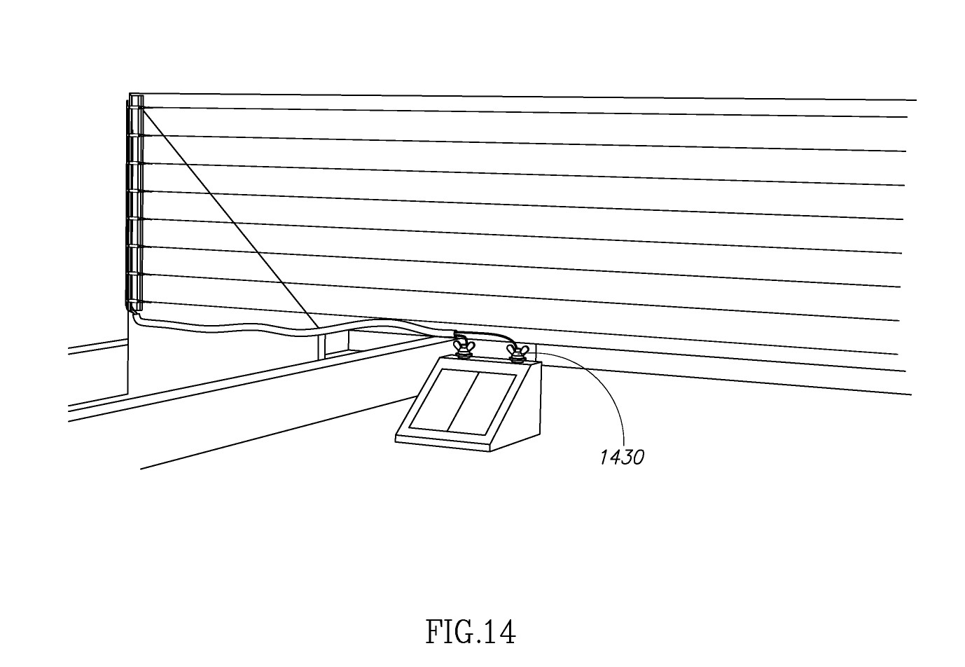

FIG. 14 shows an example parapet protector that is attached to a power source 1420. Such power sources 1420 may be solar powered or may be attached to a building power source. In some embodiments the parapet protector is electrified while in others it may not be.

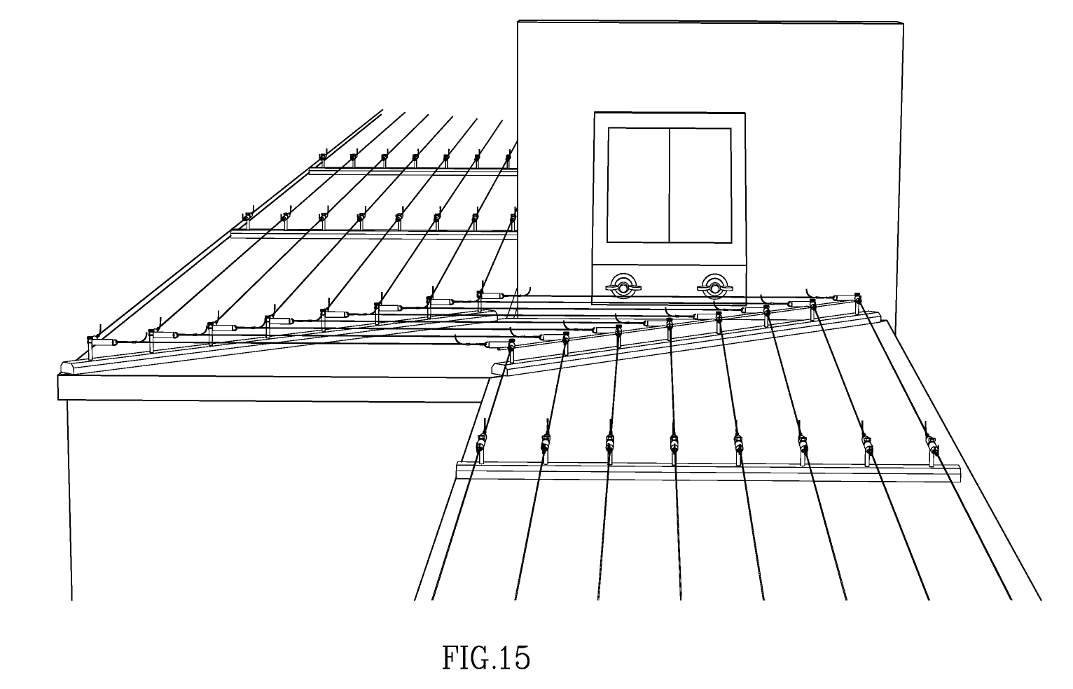

FIG. 15 shows an additional installation of a parapet protector including the power source 1520.

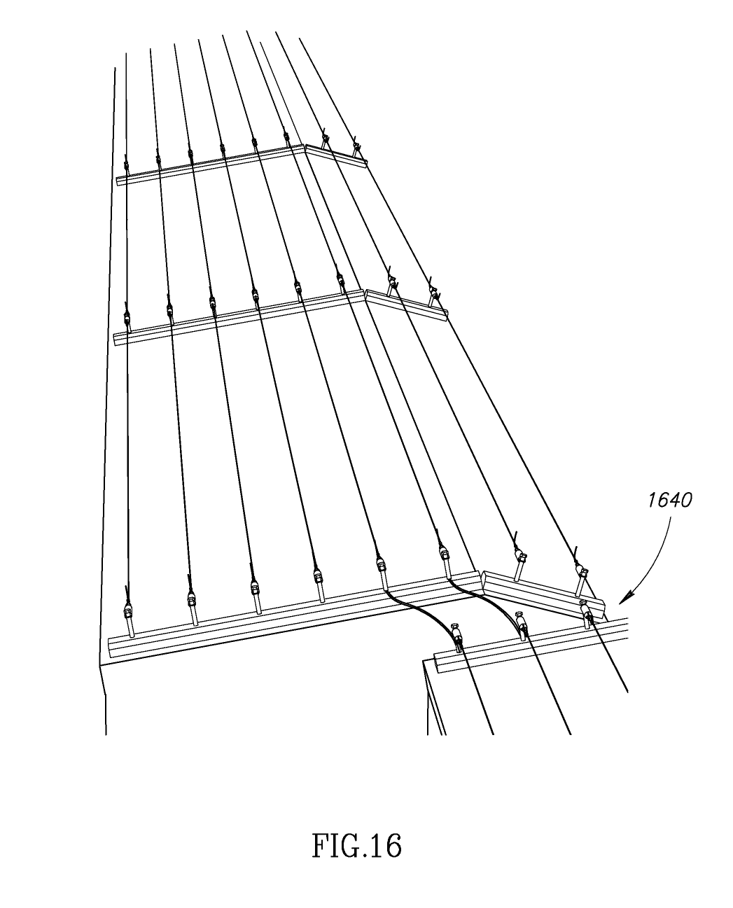

FIG. 16 shows an example parapet protector whereby there is a plurality of insulators shown attached to different slopes of the buildings parapet. For example insulators in area 1640.

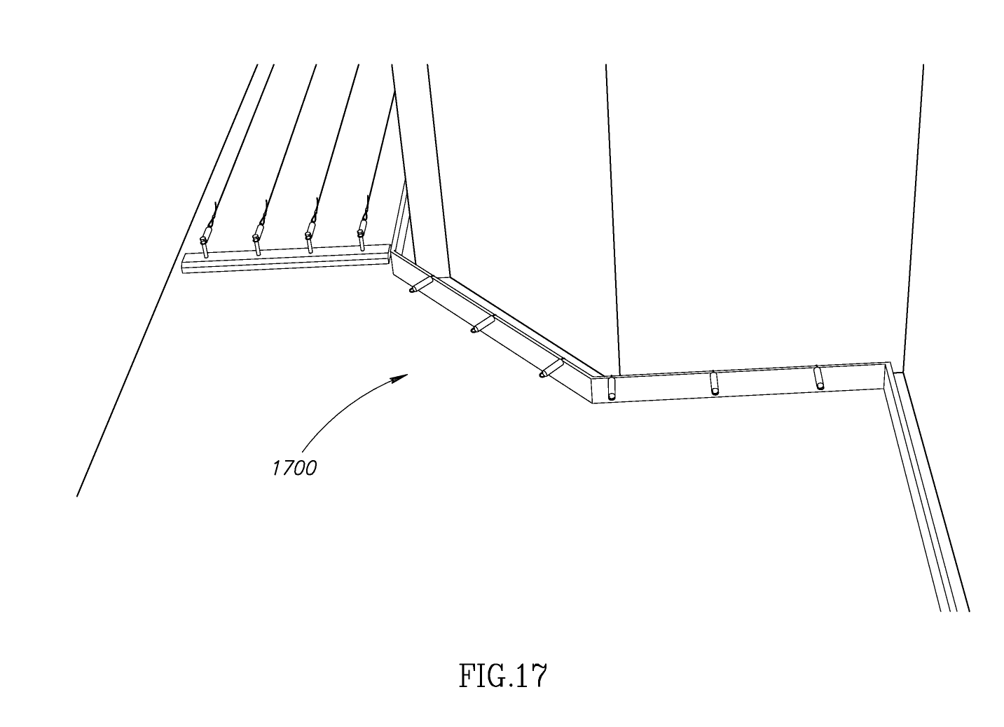

FIG. 17 shows an example angled constructions 1700 for shaping around a column, while still allowing for the installation of the suspension systems.

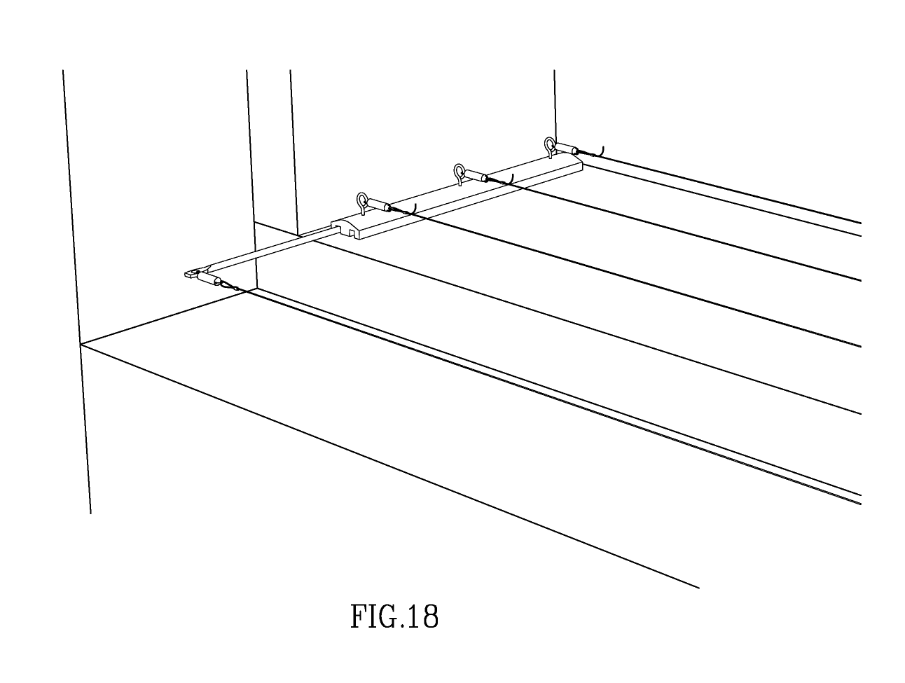

FIG. 18 shows a parapet protector installed on a window sill.

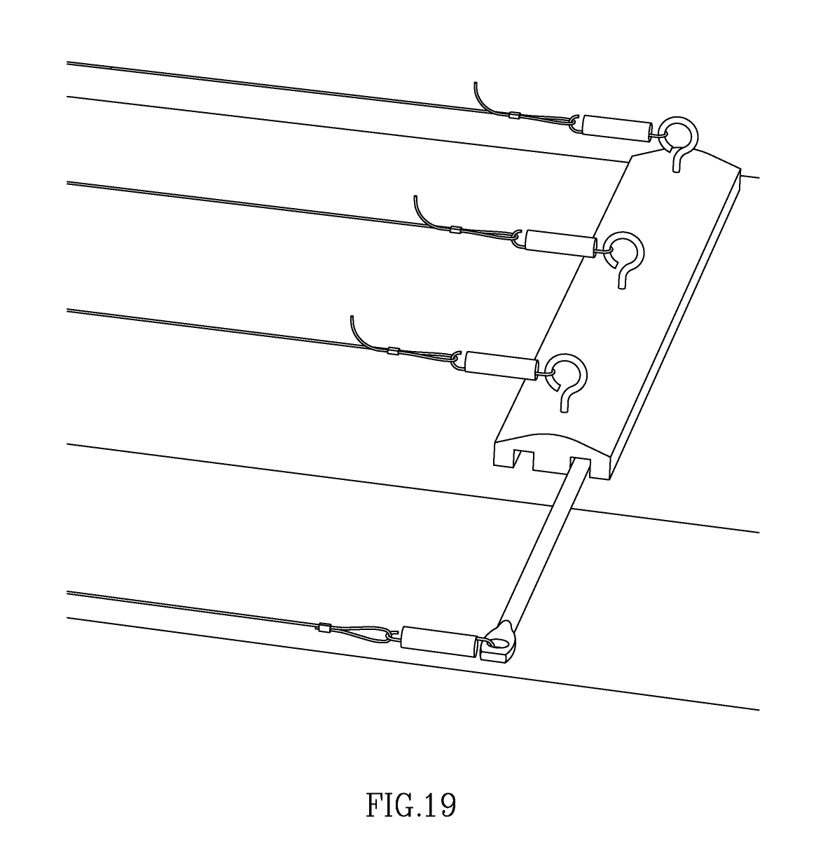

FIG. 19 shows a close up view of an example insulator 1902 showing a post 1903 extending from the insulator 1902 in a direction that is substantially parallel to the buildings surface.

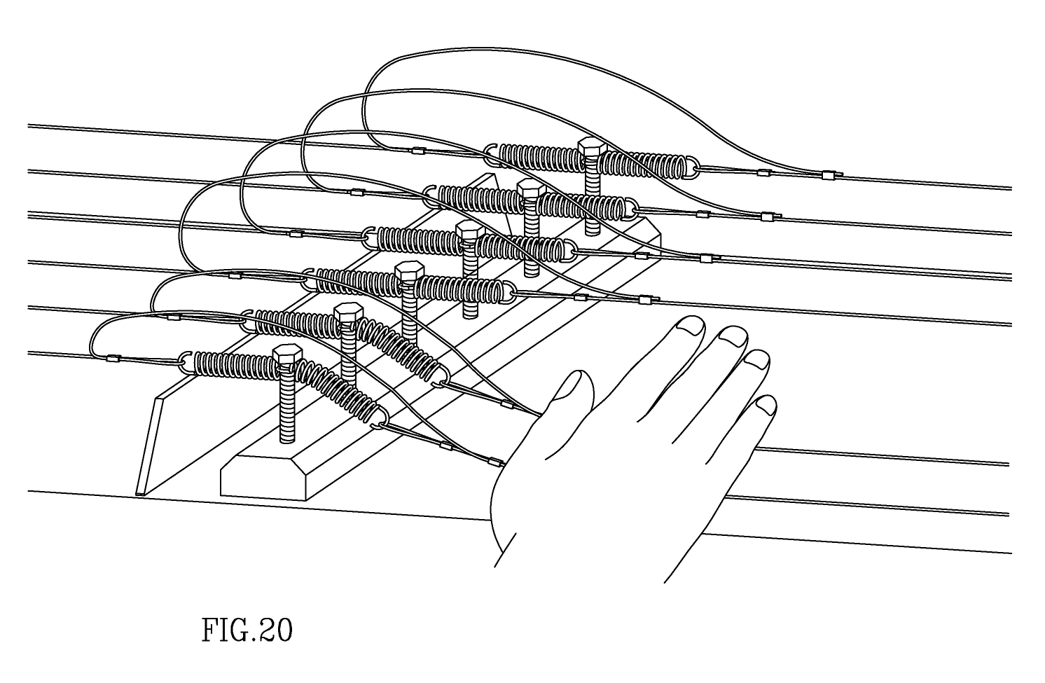

FIG. 20 demonstrates the flexibility of the suspension system, as is shown by the force of the hand applied to the system.

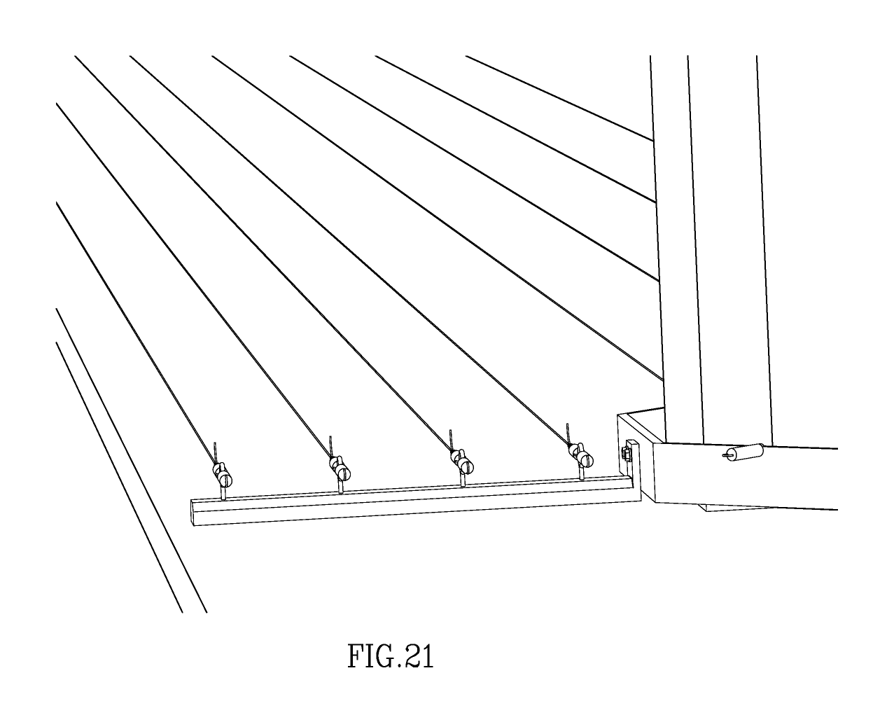

FIG. 21 shows an example installation of an example parapet protector.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

1. A parapet protector comprising:
a first insulator detachably attached to a surface of a building;
a first suspension eye coupled to the first insulator, the first suspension eye extending outwardly from the first insulator in a direction that is perpendicular to a plane defined by the surface of the building;
a first spring that is detachably attached to a distal end of the first suspension eye;
a wire that connects the first spring to a second spring located on a second suspension eye coupled to a second insulator; and
an electrical input that is configured to electrify the wire.

2. The parapet protector of claim 1, wherein the first spring and the second spring are configured such that when a force is applied to the wire in the direction of the building, the wire may come into contact with the building causing an electric shock.

3. The parapet protector of claim 1, wherein the length of the suspension eye is between one inch and four inches inclusive.

4. The parapet protector of claim 1, wherein the height of the suspension eye is adjustable.

5. The parapet protector of claim 1, further comprising:
a third spring attached to the first suspension eye attached to an additional wire extending in an alternate direction from the first spring; and
a jumper connected to the wire beyond the first spring and the additional wire beyond the third spring.

6. A bird deterrent comprising:
a first insulator detachably attached to a building surface, the first insulator having at least one post extending outwardly from the first insulator;
a second insulator spaced apart from the first insulator and detachably attached to the building, the second insulator having at least one post extending outwardly from the second insulator; and
a suspension system attached at a first end to a post on the first insulator and attached at a second end to a post on the second insulator, wherein the suspension system further comprises a first spring at the first end and second spring at the second end and a wire electrically connecting the first spring and second spring.

7. The bird deterrent of claim 7, further comprising:
a third insulator spaced apart from the first insulator and detachably attached to the building, the third insulator having at least one post extending outwardly from the third insulator, wherein a suspension system connects a post on the third insulator to the pose on the first insulator, and
a jumper configured to span the first insulator and connect the suspension systems.

8. The bird deterrent of claim 7, further comprising:
a power source connected to the wire, such that the wire is positively charged.

9. The bird deterrent of claim 8, wherein the power source is solar powered.

10. The bird deterrent of claim 7, wherein the height of the post is between one inch and four inches inclusive.

11. The bird deterrent of claim 7, wherein the height of the post is adjustable.

12. The bird deterrent of claim 8, further comprising:
a plurality of suspension systems that are attached to a plurality of posts coupled to insulators, such that the suspension systems are substantially parallel, and wherein a first suspension system of the plurality of suspension systems carries a positive charge from the power source and the second suspension system of the plurality of suspension systems carries a negative charge from the power source.

13. The bird deterrent of claim 12, wherein the plurality of the suspension systems each have a spring tension that is configured to allow a wire to extend to the building surface.
